(19) United States
(12) Patent Application Publication
(10) Pub. No.: US 2006/0067081 A1
(43) Pub. Date: Mar. 30, 2006

(54) Big improved lamp holder structure

(76) Inventor: Ho-Hsin Chiu, Hsinchu City (TW)

Correspondence Address: RABIN & BERDO, P.C., Suite 500, 1101 14th Street, Washington, DC, 20005, US

(21) Appl. No.: 10/949,240

(22) Filed: Sep. 27, 2004

(51) Int. Cl. F21V 17/06

(52) U.S. Cl. 362/437; 362/257

(57) ABSTRACT

The present invention provides a kind of Big Improved Lamp Holder Structure being composed of lamp's shell, lamp cover and lamp holder, in which the lamp head of lamp's shell is kind of small flat substance with gibbous slightly air hole part; and the lamp cover is a bell-mouthed plastic, inside, equipped with two belt clips with one notch respectively, and there is an appropriate space between them.

### FIELD OF THE INVENTION

The present invention provides a kind of Big Improved Lamp Holder Structure, whose holder is kind of small flat substance with gibbous slightly air hole part, and the lamp cover is a bell-mouthed plastic, inside, equipped with two belt clips with one notch respectively, and there is an appropriate space between them.

### BACKGROUND OF THE INVENTION

As shown in FIG. 1, the former common big lamp set was made through that covered one lamp cover (20) on the lamp neck of lamp's shell, in which the lamp cover (20) is a electrically conductive metal cover, and its surrounding surface was designed as screw thread. Revolve and fix the lamp's shell (10) and lamp cover (20) on the lamp holder (30), the big lamp set is completely finished.

Because the lamp cover (20) was made by a kind of electrically conductive metal, the cost required for manufacturing the whole lamp cover (20) and lamp holder (30), additionally, the cost during the assembling of big lamp set is high;

Furthermore, because the lamp's shell (10) and lamp cover (20) were combined with lamp holder (30) by rotating, it would be easy to loose and cause bad contact;

Therefore, based on the above-mentioned situation, the inventor of the present invention actively improve it with the rich experience on designing manufacturing the interrelated products, the Big Improved Lamp Holder Structure can be achieved.

### SUMMARY OF THE INVENTION

The main purposes of the present invention is to provide a kind of a structure, whose holder is kind of small flat substance with gibbous slightly air hole part, and the lamp cover is a bell-mouthed plastic, inside, equipped with two belt clips with one notch respectively, and there is an appropriate space between them;

The minor purposes of the present invention are to save the costs for manufacturing the lamp cover and holder made by traditional metal, and to achieve a whole assembling speed of the big lamp set; Lastly, increase more fixedness of the assembly of the big lamp set.

### BRIEF DESCRIPTION OF THE DRAWINGS

(I) Drawings:

FIG. 1: is the disassembled view of the practical invention.

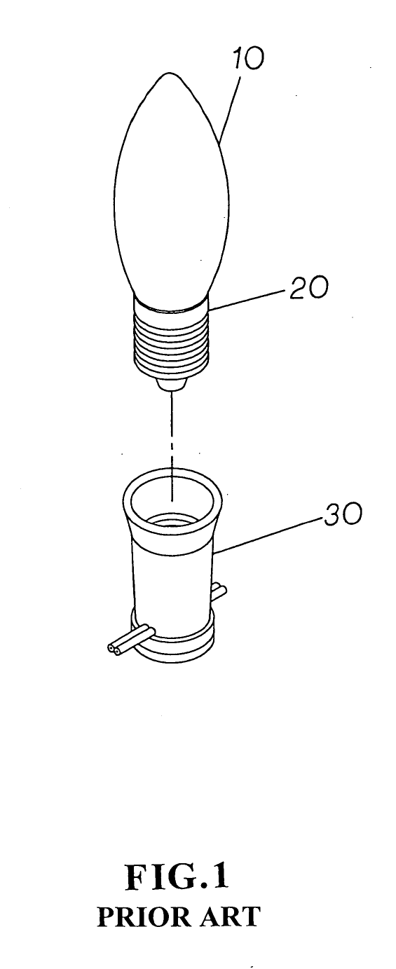

FIG. 2: is the three-dimensional disassembled view of the present invention.

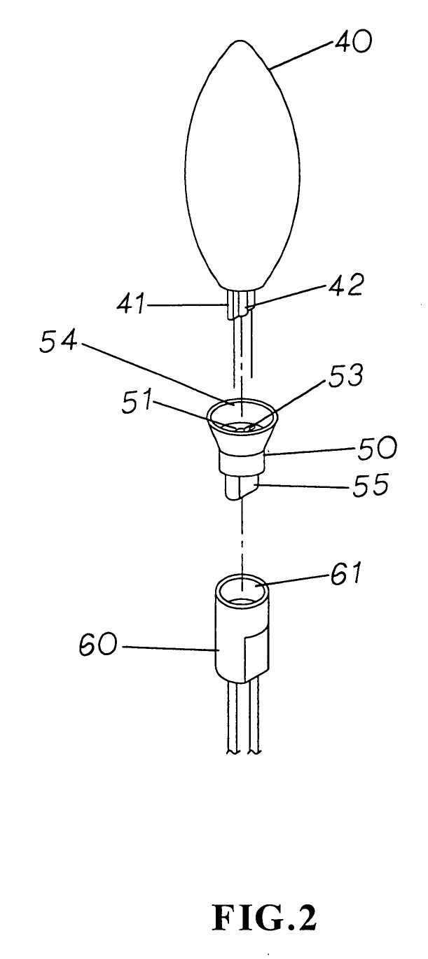

FIG. 3: is the top view of the lamp cover of the present invention.

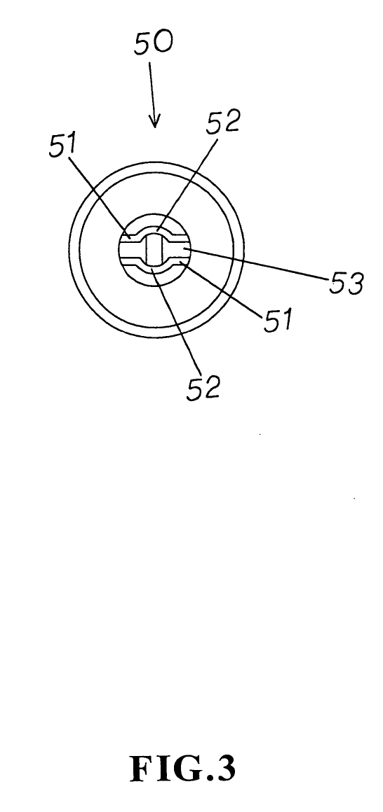

FIG. 4: is the disassembled cutaway view of the present invention.

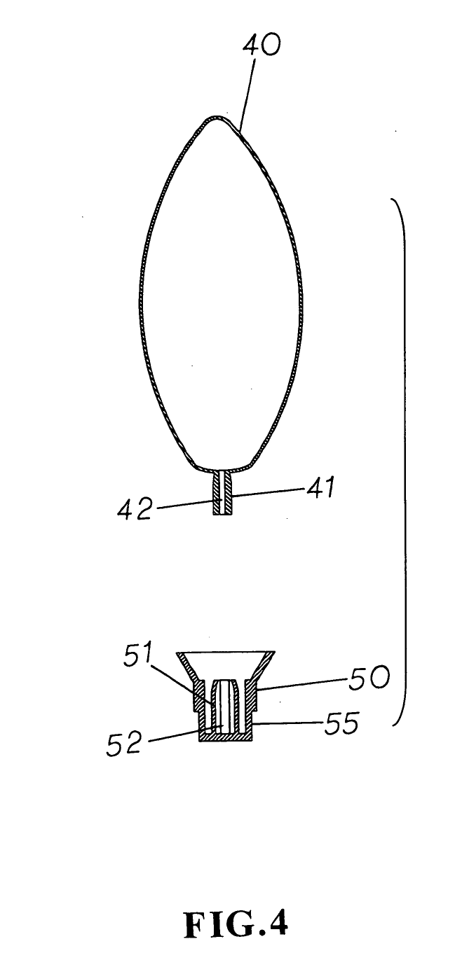

FIG. 5: is the assembled cutaway view of the present invention.

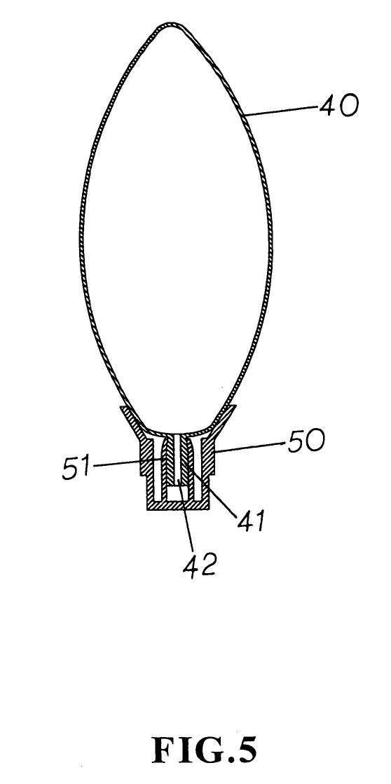

FIG. 6: is the three-dimensional assembled view of the present invention.

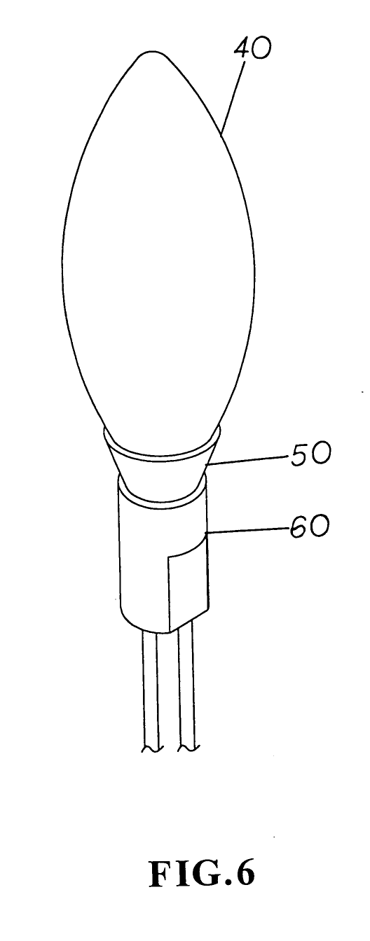

Code Number:

| | |
|---|---|
| (10) Lamp's shell | (20) Lamp cover |
| (30) Lamp holder | (40) Lamp's shell |
| (41) Lamp head | (42) Air hole part |
| (50) Lamp cover | (51) Clips |
| (52) Notch | (53) Space |
| (54) Jointing | (55) Jointing part |
| (60) Lamp holder | (61) Mouth of lamp holder |

### DETAILED DESCRIPTION OF THE INVENTION

As shown in Figure II, the big lamp set is composed of: lamp's shell (40), lamp cover (50) and lamp holder (60), in which the lamp head (41) of lamp's shell is a small flat substance with gibbous slightly air hole part (42);

As shown in Figure II and Figure III, the lamp cover (50) is a bell-mouthed plastic, inside, equipped with two belt clips (51) with one notch (52) respectively, and there is an appropriate space (53) between them (51).

As shown in Figure II to Figure VI, the lamp head (41) of lamp's shell (40) aims to the jointing (54) of lamp cover (50), and the lamp head (41) is just inserted into the space (53) between the two clips (51) of lamp cover (50); lastly, make jointing part (55) of the lamp cover (50) with lamp's shell (40) aim to the mouth (61) of lamp holder (60) and insert it into lamp holder. So the assembling of the big lamp set is finished completely.

What is claimed is:

1. A lamp holder including lamp's shell, lamp cover and lamp holder, its features include: the lamp holder is kind of small flat substance with gibbous slightly air hole part; and the lamp cover is a bell-mouthed plastic, inside, equipped with two belt clips with one notch respectively.

2. The lamp holder of claim 1, wherein the notches between the two clips are symmetrical mutually.
